(19) United States
(12) Patent Application Publication
(10) Pub. No.: US 2007/0073885 A1
(43) Pub. Date: Mar. 29, 2007

(54) DEVICE AND METHOD FOR HANDLING MEDIA SERVER OVERLOADING

(75) Inventor: HAN-TZUNG LIN, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,687

(22) Filed: Apr. 21, 2006

(30) Foreign Application Priority Data
Sep. 23, 2005 (TW) 94133072

(51) Int. Cl. G06F 15/173

(52) U.S. Cl. 709/226

(57) ABSTRACT

A device for handling a media server overloading includes a play request module, an overload detecting module and a normal playtime calculating module. The play request module is used for sending a media server a play request for allocating a media resource. The overload detecting module is used for detecting if the media server is overloaded. The normal playtime calculating module is used for calculating a normal play time if the media server is overloaded. A related method for handling the media server overloading is also provided herein.

### FIELD OF THE INVENTION

The invention generally relates to a device and a method for handling server overloading, and particularly to a device such as a set top box and a method of handling media server overloading.

### DESCRIPTION OF RELATED ART

On-demand functions play an important role in multimedia on-demand services, because they conveniently enable a user to optionally select and control the playing of content of various multimedia presentations such as movies and music. Typically, on-demand functions need to be implemented using real-time streaming protocol (RTSP).

In a typical application, a set top box transfers a setup request to a media server based on RTSP. If the media server accepts the setup request, the set top box and the media server are successfully connected. Next, the set top box sends a play request for content to the media server. Upon accepting the play request, the media server streams the content to the set top box. In the process of playing the content, if the user desires to pause, fast-forward, or rewind, he/she may use a button provided on the set top box, and subsequently a corresponding signal is sent to the media server. If the media server accepts the request, it adjusts the streaming accordingly. However, when the media server is overloaded, abnormal communication between the set top box and the media server may occur. For example, a portion of the content previously streamed may be transferred to the set top box again.

Therefore, there is a need for a device such as a set top box for properly handling media server overloading, and for a method for handling media server overloading.

### SUMMARY OF INVENTION

A device for handling media server overloading is provided. The device includes a play request module, an overload detecting module, and a normal playtime calculating module. The play request module is used for sending a media server a play request for allocating a media resource. The overload detecting module is used for checking whether the media server is overloaded. The normal playtime calculating module is used for calculating a normal play time if the media server is overloaded.

Moreover, a method for handling media server overloading is also provided. The method includes sending a play request including a range indicator to a media server, receiving a play response from the media server, detecting whether the media server is overloaded according to the play response, calculating the normal play time if the media server is overloaded, and sending another play request including the normal play time to the media server.

Other advantages and novel features will become more apparent from the following detailed description when taken in conjunction with the accompanying drawings, in which:

### BRIEF DESCRIPTION OF DRAWINGS

FIG. 1 is a block diagram of a connection between a set top box and a media server in accordance with an embodiment of the invention, also showing modules of the set top box;

FIG. 2 is a flow chart of entering a playing mode in accordance with another embodiment of the invention;

FIG. 3 is a flow chart of switching from one playing mode to another playing mode in accordance with a further embodiment of the invention; and

FIG. 4 is a flow chart of disconnecting the media server from the set top box in accordance with a still further embodiment of the invention.

### DETAILED DESCRIPTION

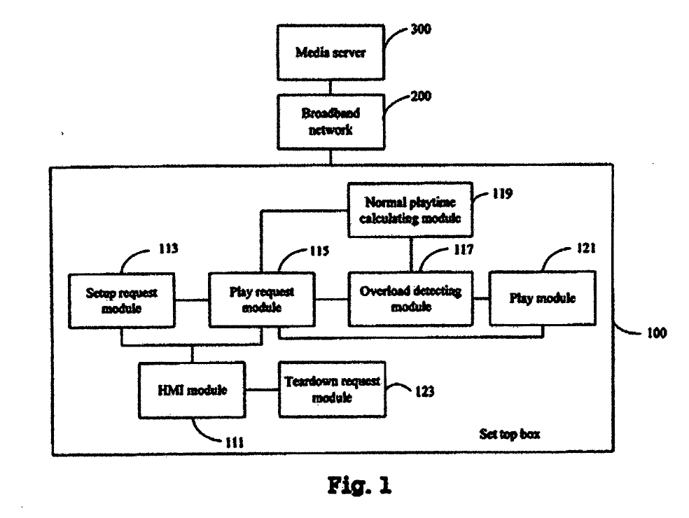

Referring to FIG. 1, a block diagram of a connection between a set top box 100 and a media server 300 in accordance with an embodiment of the invention is shown.

The set top box 100 is connected to the media server 300 via a broadband network 200. The broadband network 200 uses technology such as asymmetric digital subscriber line (ADSL), hybrid fiber coaxial (HFC) cable, and so on. The media server 300 stores a plurality of media resources that can be requested by the set top box 100.

The set top box 100 includes a human-machine interface (HMI) module 111, a setup request module 113, a play request module 115, an overload detecting module 117, a normal playtime calculating module 119, a play module 121, and a teardown request module 123.

In this embodiment, a user may control the setup request module 113, the play request module 115, and the teardown request module 123 via the HMI module 111. Operations such as setup, teardown, fast-forward, rewind, and pause may be implemented by use of the HMI module 111.

The HMI module 111 provides the user with an interface to the set top box 100. All operations of the set top box 100 are implemented via the HMI module 111.

The setup request module 113 is used to establish a communication link between the set top box 100 and the media server 300. In particular, the setup request module 113 is used for receiving a command from the HMI module 111, sending the media server 300 a setup request for a real-time stream to the set top box 100, and processing a setup response from the media server 300.

The play request module 115 is used for sending the media server 300 a play request for allocating a media resource. The play request can be either a play request including a range indicator, or a play request including a normal play time (NPT). The play request including the range indicator can be either a normal playing mode request or a particular playing mode request. If the user desires to play the media resource in a normal playing mode, he/she may control the play request module 115 via the HMI module 111 and send a normal playing mode request to the media server 300. If the user desires to play the media resource in another particular playing mode such as fast-forward, rewind, pause, and so on, he/she may control the play request module 115 via the HMI module 111 and send the particular desired playing mode request to the media server 300.

The overload detecting module 117 is used to detect overloading of the media server 300.

The normal playtime calculating module 119 is used to calculate the NPT when the media server is overloaded.

The play module 121 is used to play the media resource requested from the media server 300.

The teardown request module 123 is used to disconnect the connection between the set top box 100 and the media server 300.

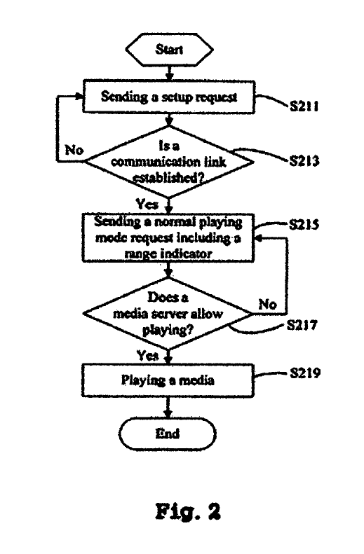

Referring to FIG. 2, a flow chart of entering a playing mode in accordance with another embodiment of the invention is shown.

The process begins in step S211, where the setup request module 113 sends a setup request for a real-time stream to the media server 300. The media server 300 allocates a media resource to the set top box 100 via the real-time stream. The setup request sent to the media server 300 by the setup request module 113 includes: an Internet protocol address of the set top box 100; an identification of the version of real-time transfer protocol (RTSP) being used; a sequence code of a current setup request sent by the set top box 100; a media format identified as being supported by the set top box 100; a transmission protocol used by the set top box 100; a communication port used by the set top box 100 to receive data; and an Internet protocol address of the media server 300. In the case where the setup request is for streaming of a video, the media format supported by the set top box 100 can, for example, be Moving Picture Experts Group-2 (MPEG-2) or Windows Media Video (WMV). The transmission protocol used by the set top box 100 can, for example, be User Datagram Protocol (UDP) or Transmission Control Protocol (TCP).

In step S213, first, the setup request module 113 waits for a setup response from the media server 300, in order to determine whether a communication link is established between the set top box 100 and the media server 300. The setup response from the media server 300 includes: the version of RTSP protocol used by the set top box 100; a status code of the setup response indicating whether the media server 300 accepts the current setup request; the sequence number of the setup response, which is identical to that of the setup request; a session ID established by the set top box 100 and the media server 300; a name of the media server 300, and the version of an operating system of the media server 300; a media format of the content received by the set top box 100 and the transmission protocol being used; a protocol used by the media server 300 to describe the media resource, for example, Session Description Protocol (SDP) or another kind of description protocol; the Internet protocol address and communication port of the media server 300; packet size of the media resource; and length of a message used to describe a media related information. In this embodiment, if the setup request is accepted, a status code ‘200’ is sent. The status code ‘200’ indicates that the set top box 100 is successfully connected to the media server 300. Otherwise, a status code ‘403’ is sent. The status code ‘403’ indicates that the current setup request has failed.

The message includes a play range. The play range includes: a Presentation Time Stamp (PTS) in the form of a bit string, such as ‘Range: pts=71287-560857513’, along with the NPT in seconds, such as ‘Range: npt=1200.00-end’. The NPT gives the current starting point in relation to the beginning of a presentation, where 0.0 represents the beginning of the presentation. Thus in the above example, ‘1200.00-end’ means the current starting point of the presentation is 1200 seconds from the beginning and should continue through to the end. In this embodiment, the PTS may also be used to calculate the NPT when the media server 300 is overloaded, as explained below.

In step S213, if the communication link is established, the process goes to step S215 described below. If the communication link is not established, the process returns to step S211 described above.

In step S215, the play request module 115 sends a play request including a range indicator corresponding to one of many possible commands to the media server 300. The play request including the range indicator further includes: at least: the Internet protocol address of the media server 300; the sequence number of the current play request, which equals that of an immediately preceding play request plus 1; a play speed (for example, ‘Scale: 1.00’ means playing at normal speed); and the number of sessions established between the set top box 100 and the media server 300.

When the current request is the first play request, and the media has not been played yet, even if the media server 300 is overloaded, the play range transferred to the set top box 100 is ‘0.00-end’, which is identical to the play range when the set top box 100 first begins playing the media. Therefore, the play range of the play request uses the range indicator ‘beginning-end’ to inform the media server 300 that the media should be played from the beginning to the end. That is, ‘Range: npt=beginning-end’ is specified as the play range.

In step S217, the play request module 115 waits for a play response from the media server 300 and detects whether the media server 300 allows playing according to the play response. The play response includes the play range, a play speed, and a setup speed of the media; the version of RTSP protocol being used; a status code for indicating whether the media server 300 accepts the play request; a serial number; a session number of the play response corresponding to that of the play request.

If the media server 300 allows playing, the process goes to step S219, where the media is played using the play module 121. If the media server 300 does not allow playing, the play request module 115 returns to step S215 described above.

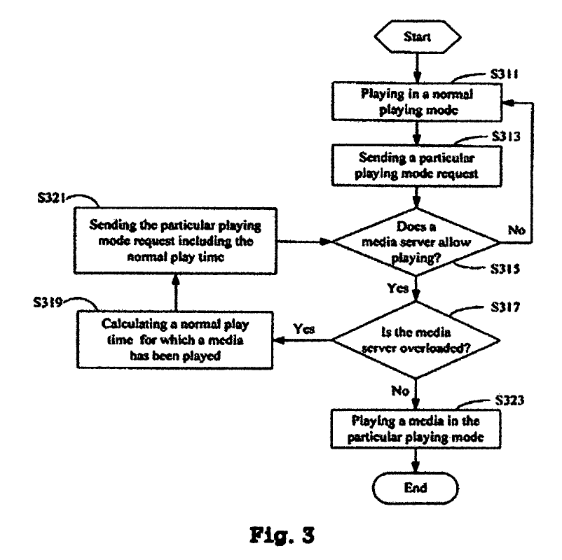

Now referring to FIG. 3, a flow chart of switching from one playing mode to another playing mode in accordance with a further embodiment of the invention is shown.

In step S311, the media is being streamed in a current playing mode. In a typical example, the current playing mode is the normal playing mode. A user then requests a change to another particular playing mode, such as fast-forward, rewind, or pause. The HMI module 111 accordingly sends relevant information to the play request module 115.

Then in step S313, the play request module 115 sends the particular playing mode request to the media server 300. In this step, the particular playing mode request includes: the serial number of the new playing mode requested, which is equal to that of the last request plus 1; the requested playing speed of the media (for example, ‘Scale: 2.00’ means a playing speed twice that of normal); and the play range indicator such as ‘current-end’ to indicate that the media is to be played from the current play time to the end.

Then in step S315, the play request module 115 waits for a play response from the media server 300 and detects whether the media server 300 allows playing according to the play response. If the media server 300 allows playing, the process goes to step S317 described below. If the media server 300 does not allow playing, the process returns to step S311 described above. For example, if the media server 300 allows playing and the play request module 115 sends a 2×-speed fast-forward play request 1200 seconds after the media starts, the play range in the play response is ‘Range: npt=1200.00-end’, and the play speed is ‘Scale: 2.00’. If media server 300 does not allow playing, the corresponding play response information is ‘Range: npt=0.00-end’ and ‘Scale: 2.00’.

In step S317, the overload detecting module 117 detects whether the play range in the play response is correct, in order to determine whether the media server 300 is overloaded. Since the media has already been playing for a period of time in the above process, the play range transferred to the play module 121 by the media server 300 should not be ‘0.00-end’ if there is no overload condition. In this embodiment, by detecting if the play range in the play response is ‘0.00-end’, the overload detecting module 117 determines whether the media server 300 is overloaded. If the play range detected is ‘0.00-end’, it indicates that the media server 300 is overloaded, and the process goes to step S319 described below. If the play range detected is not ‘0.00-end’, it indicates that the media server 300 is not overloaded, and the process goes to step S323, where the media is played in the particular playing mode.

In step S319, the normal playtime calculating module 119 calculates the NPT for which the media has been played. In this embodiment, for example, the play range is ‘Range: pts=71287-560857513’. Next, the normal playtime calculating module 119 requests a PTS value. For example, if the media resource is a video, then the normal playtime calculating module 119 requests a PTS value in an MPEG-2 frame. For example, if the PTS value is 67535839 bits and the normal playing speed of the video is 90000 bits/sec (the normal playing speed of a MPEG-format video), the NPT of the video is (67535839 bits-71287 bits)/(90000 bits/sec), which is about 750 sec.

The process then goes to step S321, where the play request module 115 sends the particular playing mode request (including the NPT calculated in step S319) to the media server 300. The process then returns to step S315.

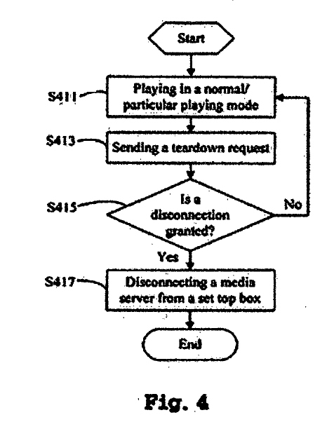

Now referring to FIG. 4, a flow chart of disconnecting the media server 300 from the set top box 100 in accordance with a still further embodiment of the invention is shown.

In step S411, the play module 121 is playing, either in the normal mode or in a particular playing mode. The HMI module 111 detects a teardown operation performed by the user, and accordingly sends relevant information to the play request module 115.

In step S413, the teardown request module 123 sends a teardown request to the media server 300.

In step S415, the teardown request module 123 waits for a teardown response from the media server 300, in order to determine whether a disconnection is granted by the media server 300. If the media server 300 grants a disconnection, the process goes to step S417, where the media server 300 is disconnected from the set top box 100. If the media server 300 does not grant a disconnection, the process returns to step S411, where the play module 121 continues playing.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A device for handling media server overloading, comprising:
a play request module for sending a media server a play request for allocating a media resource;
an overload detecting module for detecting whether the media server is overloaded; and
a normal playtime calculating module for calculating a normal play time if the media server is overloaded.

2. The device according to claim 1, further comprising a setup request module for establishing a connection link between the device and the media server.

3. The device according to claim 2, further comprising a teardown request module for disconnecting the communication link between the device and the media server.

4. The device according to claim 3, further comprising a human-machine interface (HMI) module for controlling the setup request module, the play request module, and the teardown request module.

5. The device according to claim 1, further comprising a play module for playing the media resource requested from the media server.

6. The device according to claim 1, wherein the play request sent by the play request module comprises a play request comprising a range indicator and a play request comprising a normal play time.

7. The device according to claim 6, wherein the play request comprising the range indicator further comprises a normal playing mode request for playing in a normal mode and a particular playing mode request for playing in a mode other than the normal mode.

8. The device according to claim 1, wherein the device is a set top box.

9. A method for handling media server overloading, comprising:
sending a play request comprising a range indicator to a media server;
receiving a play response from the media server;
detecting whether the media server is overloaded according to the play response;
calculating a normal play time if the media server is overloaded; and
sending another play request comprising the normal play time to the media server.

10. The method according to claim 9, wherein the play response comprises a presentation time stamp.

11. The method according to claim 10, wherein the play response further comprises the normal play time.

12. The method according to claim 11, wherein the normal play time is derived from the presentation time stamp.

13. The method according to claim 9, wherein the media server sends the play response comprising the normal play time according to the play request comprising the normal play time.

14. The method according to claim 9, wherein the play request and the play response are sent via real-time streaming protocol.

15. The method according to claim 9, further comprising:
sending a setup request to the media server; and
receiving a setup response.

16. The method according to claim 9, wherein the play request comprising the range indicator further comprises a normal playing mode request for playing in a normal mode and a particular playing mode request for playing in a mode other than the normal mode.

17. The method according to claim 9, wherein the media server plays in either a normal playing mode or a particular playing mode.
